(19) United States
(12) Patent Application Publication
(10) Pub. No.: US 2008/0128649 A1
(43) Pub. Date: Jun. 5, 2008

(54) Synthesis of Nanocomposites Including Metal Oxides and Metallic Alloys

(76) Inventors: Vivek Mehrotra, Simi Valley, CA (US); Ira Goldberg, Thousand Oaks, CA (US)

Correspondence Address: SLATER & MATSIL, L.L.P., 17950 PRESTON RD, SUITE 1000, DALLAS, TX, 75252-5793, US

(21) Appl. No.: 11/854,959

(22) Filed: Sep. 13, 2007

Related U.S. Application Data
(63) Continuation-in-part of application No. 10/837,552, filed on Apr. 30, 2004.

(51) Int. Cl. H01F 1/00; C08K 3/22; C09K 11/02

(52) U.S. Cl. 252/62.54; 524/430; 524/432; 524/431; 524/435; 252/301.36

(57) ABSTRACT

A method of forming nanocomposites within a polymer structure includes exposing a wettable polymer having ion-exchangeable groups pendant therefrom to an aqueous solution of a soluble salt containing metal ions, the metal ions replacing, by ion exchange, the pendant groups on the polymer. After ion exchange, the polymer is repetitively exposed to an oxidizing and/or reducing agent to form metal oxides, metal particles, metallic alloys, or combinations and mixtures thereof, trapped within the polymer structure.

This application is a continuation in part of, and claims priority to, U.S. patent application Ser. No. 10/837,552, entitled “Synthesis of Magnetic, Dielectric or Phosphorescent Nano Composites,” filed on Apr. 30, 2004, which is incorporated herein by reference.

### TECHNICAL FIELD

This invention relates to a technique for the synthesis of nanocomposites. The technique is based on ion exchange and precipitation within a polymer matrix. The matrix can be in the form of powders, fibers, tubes, self-supported films, or other three-dimensional structures. The nanocomposites may be magnetic, magnetostrictive, magneto-optic or phosphorescent.

### BACKGROUND

Prior attempts to prepare magnetic nanocomposites have utilized ground or milled particles of magnetic materials which were then dispersed in a carrier matrix, coated onto fabrics, or added to finely ground, dispersed resins or zeolites. For example, Forder, et al., in the article entitled “Preparation and Characterization of Superparamagnetic Conductive Polyester Textile Composites,” J. Mater. Chem., 3 (6), pp. 563-569, 1992, which is incorporated herein by reference, describes the preparation of magnetic colloids that are then coated onto the surface of a polyester fabric. Zhang, et al., in the article entitled “Generation of Magnetic Metal Particles in Zeolite by Borohydride Reduction at Ambient Temperature,” J. Mater. Chem. 6(6) pp. 999-1004 (1996), which is incorporated herein by reference, treats sodium mordenite, a form of the naturally occurring zeolite designated hydrated calcium sodium potassium aluminum silicate, with a water soluble salt of a metal, M²⁺, where M is iron (Fe), cobalt (Co) or nickel (Ni), to replace sodium⁺ (Na⁺) on the resin with the metallic ion. An aqueous suspension of the resin is then reacted with sodium borohydride (NaBH₄) to reduce the metallic ion to the metal M, which remains within the resin particles. These and other processes of the prior art cited below only produce individual metallic particles, not metal oxides or mixtures of both, and only describe individual metallic particles of Fe, Co, and Ni, not a mixture of two metals (e.g., FeCo or NiFe). In addition, these processes of the prior art do not include mixtures of a metal or metallic alloy and a metal oxide.

Ziolo, R. F., E. P. Giannelis, B. A. Weinstein, M. P. O'Horo, B. N. Ganguly, V. Mehrotra, M. W. Russell, and D. R. Huffman, in the article entitled “Matrix Mediated Synthesis of γFe₂O₃: A New Optically Transparent Magnetic Material,” Science 257, pp. 219-223, 1992, which is incorporated herein by reference, reported on the preparation of iron oxide (Fe₂O₃) nanoparticles in sulfonated polystyrene-type 50-100 micron beads of an ion exchange resin. They then had to be molded into monolithic structures at temperatures that modify the properties and characteristics of the nanoparticles. Sourty, D. H. Ryan and R. H. Marchessault, in the article entitled “Ferrite-Loaded Membranes of Microfibrillar Bacterial Cellulose Prepared by In Situ Precipitation,” Chem. Mater., 10(7), pp. 1755-1757, 1998 and L. Raymond, J.-F. Revol, D. H. Ryan, R. H. Marchessault, in the article entitled “In Situ Synthesis of Ferrites in Cellulosics,” Chem. Mater., 6(2), pp. 249-255, 1994, both of which are incorporated herein by reference, describe the formation of ferrites in cellulosics. Suber, et al., in the article entitled “Synthesis, and Structural and Morphological Characterization of Iron oxide-Ion-Exchange Resin and -Cellulose Nanocomposites,” Applied Organometallic Chemistry, 15, pp. 414-420, 2001, which is incorporated herein by reference, report on further studies of such materials. Shahinpoor, et al., in the article entitled “Ionic Polymer-Metal Composites: I. Fundamentals,” Smart Mater. Struct., 10, pp. 819-833, 2001, which is incorporated herein by reference, report on the treatment of ion exchange resins, such as Nafion, with platinum salts to deposit platinum on or in a matrix.

Several patents have been issued to Ziolo directed to magnetic nanocomposite compositions and processes for preparing these materials (see, e.g. U.S. Pat. Nos. 4,474,866, 5,714,536 and 6,048,920, which are incorporated herein by reference). In particular, these patents are directed to magnetic nanocomposite compositions containing nanocrystalline iron oxide (Fe₃O₄) particles formed in and stabilized by an ion binding polymeric matrix. In particular, granules of ion exchange polymer resin are suspended in a liquid and are then loaded with iron ions. The iron ions are then chemically converted to a magnetic oxide. For example, polystyrene [(SO₃⁻)₂Fe⁺²] resin is reacted with sodium hydroxide (NaOH) and hydrogen peroxide (H₂O₂) or hydrazine (N₂H₄) and NaOH to yield polystyrene [(SO₃⁻Na⁺)ₙ] plus gamma Fe₂O₃, the oxide being dispersed in the polymer matrix with particle sizes from about 0.0001 to about 0.1 microns in diameter. The end product is a very fine powder of the resin including the magnetic oxide for use as a toner for reprographic application.

Treatment of oxides with sodium borohydride has been used since the early 1970s to produce the oxide of the metal and to form nanoparticles. However, they were not called “nanoparticles” at that time, as indicated in the articles by W. O Freitag, T. A. Sharp, A. Baltz, and V. Suchodolski, entitled “Composition of Iron Powders Prepared by a Borohydride Process,” J. Appl. Phys., 50, pp. 7801-7803, 1979, and T. Uehori, A. Hosaka, Y. Tokuoka, and Y. Imaoka, entitled “Magnetic Properties of Iron-Cobalt Alloy Particles for Magnetic Recording Media, IEEE Trans. on Magnetics, 14, pp. 852-854, 1978, both of which are incorporated herein by reference. The W. O. Freitag article points out that borohydride reduction methods have been well established, though not necessarily for nanoparticle alloys. Further, the nanoparticle alloys were not dispersed within the polymer structure.

U.S. Pat. No. 6,107,233, to Harmer, et al., which is incorporated herein by reference, is directed to the formation of spherically shaped porous microcomposites of perfluorinated ion-exchange resins with inorganic oxides dispersed therethrough starting from a mixture of a water-miscible inorganic oxide and a water-miscible ion-exchange resin. The mixture is then mixed with an organic liquid in which neither the oxide nor the resin is soluble to create a dispersion of the water-miscible phase, in the form of spherical bubbles throughout the organic phase, followed by gelation of the water-miscible components into spherical particles.

In general, nanomaterials can be fabricated with magnetic, magnetostrictive, or magneto-optic functionality. Phosphorescent nanocomposites have also been synthesized using the same technique. The nanocomposites can provide improved materials for various applications such as magnetics for power converters, actuators for artificial muscles, valves, micro-mirrors and micropumps, magneto-optical wave guides and switches, magnetics for guiding micro-catheters and for drug delivery, magnetodielectric materials for microwave and radio frequency (RF) devices, and applications requiring functional conformable materials, controlled displacement or positioning devices, including macro- and micro-devices.

### SUMMARY OF THE INVENTION

Magnetic, magnetostrictive, magneto-optic, and/or phosphorescent nanocomposites and methods of preparing such nanocomposites from precursor materials are described. Suitable precursor substrate materials include films, membranes, fibers, or fabrics of ionomeric or cellulosic polymers. Metallic ions that can be deposited as nanocomposites in these substrates include iron, cobalt, nickel, magnesium, and zinc. Other metallic ions contemplated within the broad scope of the invention include vanadium, chromium, gallium, silver, arsenic, selenium, indium, antimony, samarium, neodymium, boron, silicon, and combinations thereof. Nanocomposite metals, metallic alloys, metal oxides, and mixed compounds including mixtures of metal oxides and metallic alloys can be produced by processes and methods introduced herein.

The foregoing has outlined rather broadly the features and technical advantages of the present invention in order that the detailed description of the invention that follows may be better understood. Additional features and advantages of the invention will be described hereinafter which form the subject of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention.

### BRIEF DESCRIPTION OF THE DRAWINGS

While the parent application file contains at least one drawing executed in color, the related FIGUREs provided herewith illustrate the pertinent features with shading.

FIG. 1 illustrates a chemical reaction for synthesizing a nanocomposite including a single or mixed metal oxides within an ion exchange polymer matrix incorporating features according to the principles of the present invention;

FIG. 2 illustrates a chemical reaction for synthesizing a nanocomposite including metal particles, a metallic alloy, or a mixed metallic alloy within an ion exchange polymer matrix incorporating features according to the principles of the present invention;

FIG. 3 illustrates a chemical reaction for synthesizing a nanocomposite including metallic particles and a single or mixed metallic alloys within an ion exchange polymer matrix incorporating features according to the principles of the present invention;

FIG. 4 illustrates a chemical reaction for synthesizing a mixed compound including mixed metallic alloys and metal oxides within an ion exchange polymer matrix incorporating features according to the principles of the present invention;

FIG. 5 is a graph showing the effect of an aspect ratio of nanoparticles on apparent relative magnetic permeability;

FIG. 6 is a photograph showing the effect of nanoscale particles present at increasing concentrations synthesized in a matrix using the synthesis procedure of FIG. 1;

FIG. 7 is an electron micrograph of the 5% by volume sample shown in FIG. 6;

FIG. 8 is the generalized chemical structure of a cellulosic matrix starting material for use in a process incorporating features of the present invention;

FIG. 9 is a graph showing the change in magnetic properties resulting from producing larger Fe₂O₃ nanoparticles in a matrix by repeating the deposition cycle at least 8 times according to the principles of the present invention;

FIG. 10 is the graph of FIG. 9 with each cycle normalized to the sixth cycle;

FIG. 11 is a graph showing the change in magnetic properties resulting from producing larger manganese ferrite (MnFe₂O₄) nanoparticles in a matrix by repeating the deposition cycle at least 8 times according to the principles of the present invention; and

FIG. 12 is a graph showing the change in magnetic properties resulting from producing larger cobalt ferrite (CoFe₂O₄) nanoparticles in a matrix by repeating the deposition cycle at least 8 times according to the principles of the present invention.

### DETAILED DESCRIPTION OF ILLUSTRATIVE EMBODIMENTS

Various different wettable polymers can be used as starting materials for synthesis of nanocomposite materials. These polymer materials may be provided in a wide range of forms including, but not limited to, films, pellets, powders, fibers, fabrics, and coatings on supporting materials. For illustrative purposes, ionomers containing ion exchange groups and cellulosic fibers are discussed in detail hereinbelow.

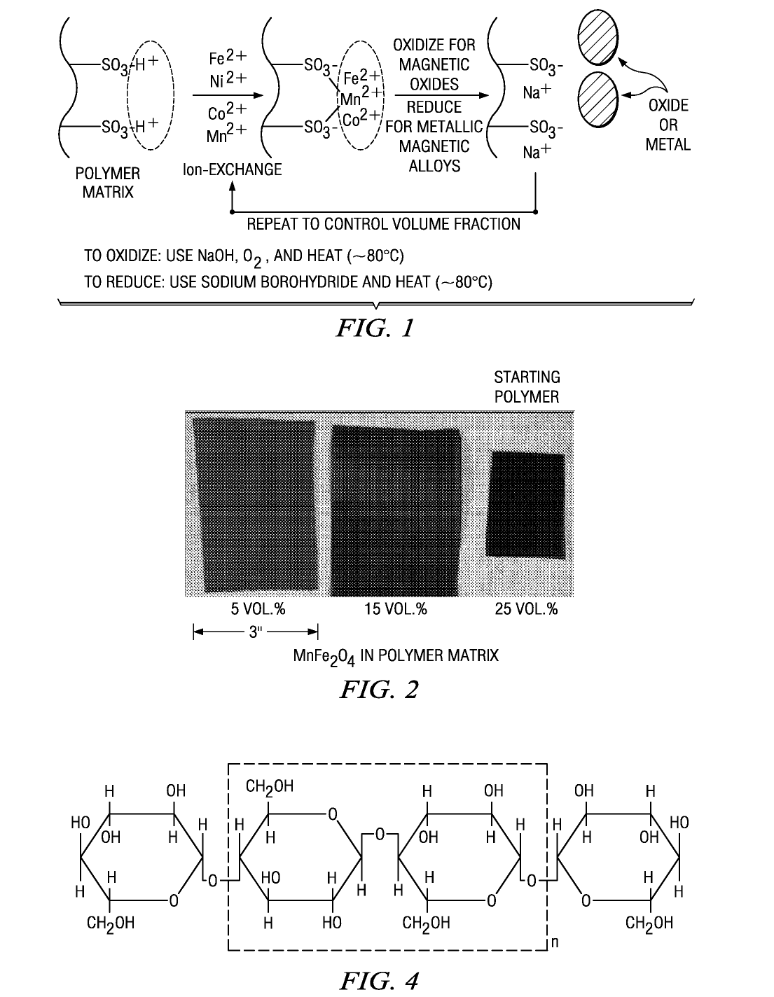

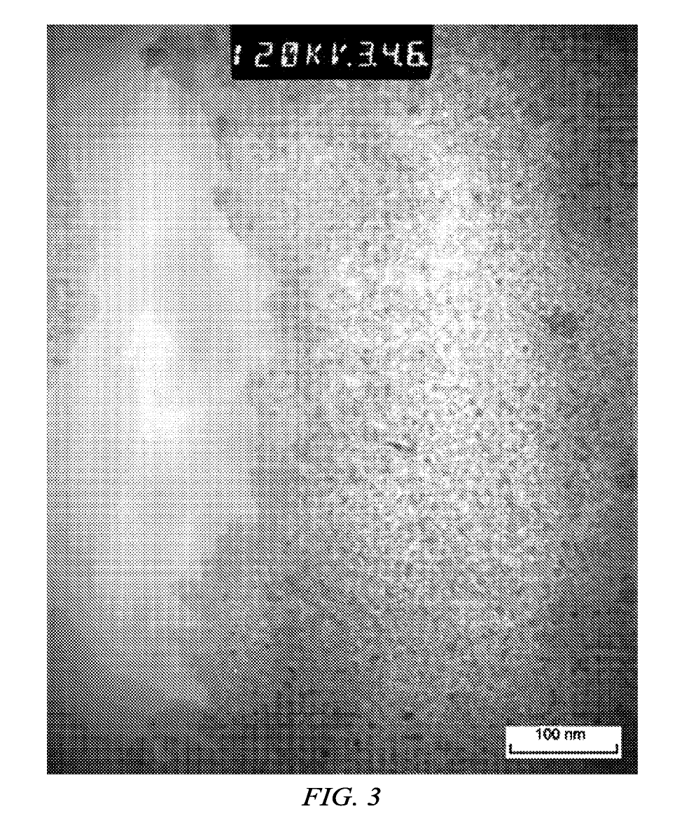

While not intending that the process be limited by theory, FIGS. 1 to 4 illustrate a preparative process describing the synthesis of nanocomposite materials starting from a polymer matrix of an ionomer containing ion-exchange groups such as widely used for water filtration and in fuel cells. FIG. 1 illustrates synthesis of a single or mixed metal oxides and a single or mixed metal oxide nanocomposite material. FIG. 2 illustrates synthesis of metallic particles, a metallic alloy, or a mixed metallic alloy. FIG. 3 illustrates synthesis of metallic particles and a single or mixed metallic alloys including, for example, cobalt and nickel-iron and cobalt-iron metallic alloys. FIG. 4 illustrates synthesis of mixed compounds including mixtures of metal oxides and metallic alloys.

An exemplary preferred polymer matrix of an ionomer containing ion-exchange groups is sold under various trade names including Nafion, Dowex, etc. The polymer matrix is based on sulfonated Teflon polymer chains with hydrogen ions balancing the charge. The nanoscale magnetic, magnetostrictive, magneto-optic, or phosphorescent materials are synthesized within the polymer matrix using ion exchange and chemical precipitation procedures at a temperature of about 60 degrees Celsius (° C.). The polymer matrix restricts the agglomeration of the nanoparticles that form and maintains the nanoparticles within confined areas of the host matrix. The concentration of nanoparticles within the matrix can be increased by repeating the ion exchange and precipitation procedures and thus provides a means for controlling the volume fraction of nanoparticles. This process also provides a means for synthesizing different materials such as metal particles, metallic alloys, metal oxides, and combinations thereof, for altering metallic properties within a host matrix, and/or for controlling a volume fraction of nanoparticles (see, e.g., the description of FIGS. 1-4 below) to yield magnetodielectric materials as well as magnetic materials with tuned properties.

As illustrated in FIG. 1, an ion-exchange process followed by oxidation with sodium hydroxide can be performed repetitively, as indicated by arrow 102, to increase the volume fraction of a metal oxide or mixed metal oxides (designated 101) to alter end material properties. Exemplary mixed metal oxides such as MnₓCo₁₋ₓFe₂O₄ and NiₓMn₁₋ₓFe₂O₄, where x=0 to 1, can be produced. In the process, a polymer matrix including sulfite groups with attached hydrogen ions is ion-exchanged in an aqueous solution in the presence of metallic ions such as, without limitation, Fe²⁺, Ni²⁺, CO²⁺, or Mn²⁺. The metallic ions are oxidized by sodium hydroxide. The addition of a few drops of hydrogen peroxide results in the direct precipitation of metal oxides.

As illustrated in FIG. 2, metallic alloys and mixtures thereof (designated 201) such as NiₓFe₁₋ₓ, CoₓFe₁₋ₓ, and MnₓFe₁₋ₓ, where x=0 to 1, can be synthesized using the ion-exchange method with subsequent reduction of ions to a metallic state using sodium borohydride. The ion-exchange process can be similarly repeated, as indicated by arrow 202, to increase a volume fraction of a metallic alloy or a mixture of metallic alloys to alter a property of an end product. Elements in FIG. 2 and following figures that are similar to those described with reference to FIG. 1 will not be redescribed in the interest of brevity.

As illustrated in FIG. 3, sodium borohydride can be used to synthesize a mixture of one or more metal particles and one or more metallic alloys. In FIG. 3, exemplary cobalt and/or iron particles are designated 301, and exemplary alloys of NiₓFe₁₋ₓ, and/or CoₓFe₁₋ₓ are designated 302, where x=0 to 1. The ion-exchange process can be similarly repeated, as indicated by arrow 303, to increase a volume fraction of a metal particle, metallic alloy, or a mixture of metallic alloys to alter a property of an end product. Exemplary metallic alloys include, without limitation, Ni—Fe, Sm—Co, Mn—Co, Sm—Fe, Mn—Fe, Co—Fe, and combinations thereof.

As illustrated in FIG. 4, following ion exchange of a metallic ion specie with a polymer matrix, the addition of a few drops of an oxidizing agent, such as hydrogen peroxide, results in the production in a nanocomposite material of metal oxides (designated 401) examples of which, without limitation, are MnₓCo₁₋ₓFe₂O₄ or NiₓMn₁₋ₓFe₂O₄, x=0 to 1. Following further ion exchange of a metallic ion specie with the polymer matrix, the application of sodium borohydride results in the production of one or more metallic alloys (designated 402) examples of which, without limitation, are NiₓFe₁₋ₓ, CoₓFe₁₋ₓ, MnₓFe₁₋ₓ, x=0 to 1, to form a mixed compound. These ion exchange and precipitation processes can be repeated as needed, as illustrated by the arrows 410 and 411, to alter metallic properties within a host matrix and/or to increase a volume fraction of produced materials. In this manner a mixture of metal oxides and metallic alloys in a polymer matrix can be produced, forming thereby a mixed compound. Exemplary mixed compounds include, without limitation, MnₓCo₁₋ₓFe₂O₄ and higher volume fraction of NiₓFe₁₋ₓ, higher volume fraction of MnₓCo₁₋ₓFe₂O₄ and NiₓFe₁₋ₓ, MnₓCo₁₋ₓFe₂O₄ and (NiₓFe₁₋ₓ and Co particles) or (NiₓFe₁₋ₓ and CoₓFe₁₋ₓ), (MnₓCo₁₋ₓFe₂O₄ and NiₓMn₁₋ₓFe₂O₄) and NiₓFe₁₋ₓ, (MnₓCo₁₋ₓFe₂O₄ and NiₓMn₁₋ₓFe₂O₄) and (NiₓFe₁₋ₓ and Co particles) or (NiₓFe₁₋ₓ and CoₓFe₁₋ₓ).

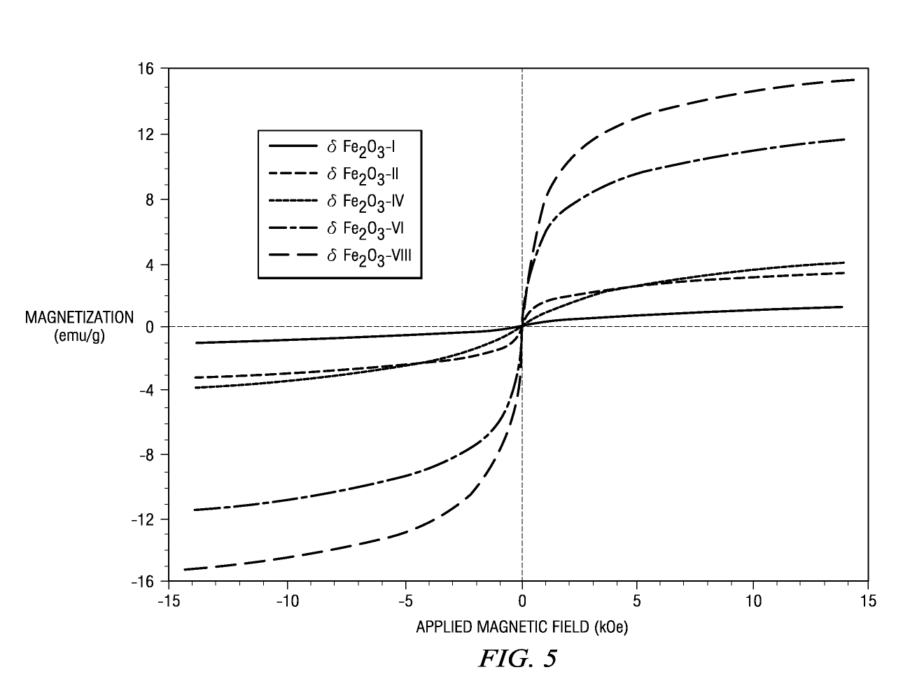

Stretching the host matrix, which can be in the form of fibers or films, gives rise to elongated areas within which nanoparticles precipitate, and thus provides a means for controlling nanoparticle shape. This may be necessary in some applications to increase magnetic permeability. As illustrated in FIG. 5, the aspect ratio (e.g., a length-to-diameter ratio) of nanoparticles can affect their apparent relative magnetic permeability. Apparent relative magnetic permeability can be approximated by the equation:

$${μ}^{′} = \frac{1}{\frac{1}{μ} - \frac{N}{4 π}} ,$$

wherein μ′ is apparent permeability, μ is true permeability, and the variable N is a demagnetizing factor proportional to a particle diameter-to-length ratio, illustrating the advantage of a high nanoparticle aspect ratio. Thus, high permeability can be achieved by nanoparticle shaping, resulting from stretching the host matrix.

The host matrix can be stretched by heating, then stretching, followed by cooling. For stretching a host matrix such as Nafion, heating should be limited to a temperature less than 150° C., as will be recognized by one skilled in the art.

Thus, the ion-exchange process introduced herein results in a nanomaterial microstructure wherein the magnetic or other nanoparticles are advantageously uniformly distributed throughout the bulk of the matrix. The magnetic or other nanoparticles are separated by polymer, which forms the overall matrix, resulting in higher saturation magnetic field strength. Furthermore, the nanoscale size of the polymer-separated nanoparticles results in disruption of eddy currents, thereby reducing losses and retaining magnetic permeability at high frequencies.

The sulfonated Teflon polymer Nafion has the formula:

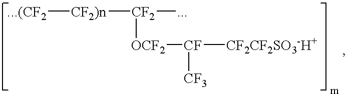

wherein a portion of the polymer chain is represented by:

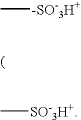

When a matrix in the form of a film composed of sulfonated polymer is placed in an aqueous solution of a soluble metal salt, hydrogen⁺ (H⁺) ions on the polymer side chains are replaced, in an ion exchange reaction, by the metal ions (e.g., Fe²⁺, Ni²⁺, CO²⁺, Mn²⁺) from the solution. However, other metallic ions of a lesser or greater volume can also be used. The resultant polymer with bound metal ions can then be heated at temperatures from about 20° C. to about 100° C., preferably around 60° C.-80° C., with alkali metal hydroxides, such as sodium hydroxide or potassium hydroxide. The result is Na⁺ or potassium⁺ (K⁺) ions replacing the metal ions and the formation of metal oxides in the form of nanoparticles entrapped within the polymer film. Alternatively, rather than oxidizing the sulfonate polymer, it may be reduced, for example by using sodium borohydride, to form metallic alloys. Examples of suitable metallic salts include, but are not limited to, soluble salts of iron (Fe), cobalt (Co), nickel (Ni), manganese (Mn), vanadium (V), chromium (Cr), and zinc (Zn). These soluble salts can be in the form of chlorides, iodides, bromides, fluorides, sulfates, acetates, nitrates, perchlorates, thiocyanates, thiosulfates, and the like. However, one skilled in the art will recognize the soluble salts with anions and cations may be used in the described procedure. Preferred salts include, without limitation, Fe²⁺, Ni²⁺, CO²⁺, Mn²⁺, Fe³⁺, and Zn²⁺. These salts may also be provided alone or in combination. When combined, mixtures of oxides or bimetallic oxides (or tri-metallic or multi-metallic oxides) designated as MO can result. Typical nanoparticles produced include iron oxide (Fe₂O₃), manganese ferrite (MnFe₂O₄), cobalt ferrite (CoFe₂O₄), nickel ferrite (NiFe₂O₄), samarium ferrite (SmFe₂O₄), nickel-iron (Ni—Fe) alloys, and zinc oxide (ZnO).

While FIGS. 1-4 show a starting polymer matrix, which may be a film, containing H⁺ ions, other soluble exchangeable ions may be used such as other cations. For example, the Na⁺ containing molecule shown as the end product in FIG. 1 can be recycled and used as the starting material for exchange with the metal ion.

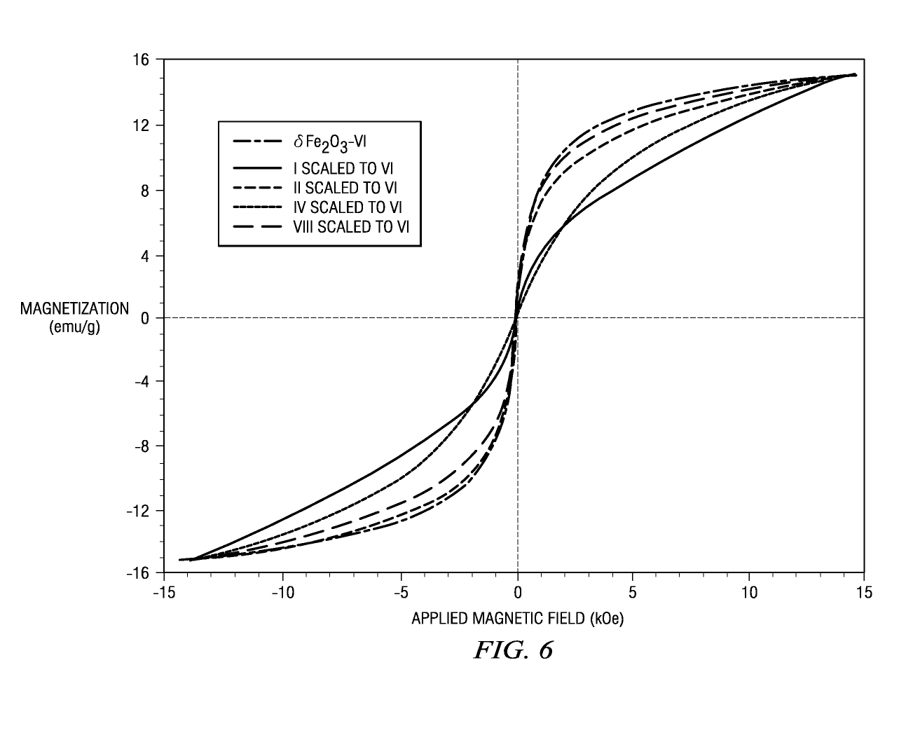

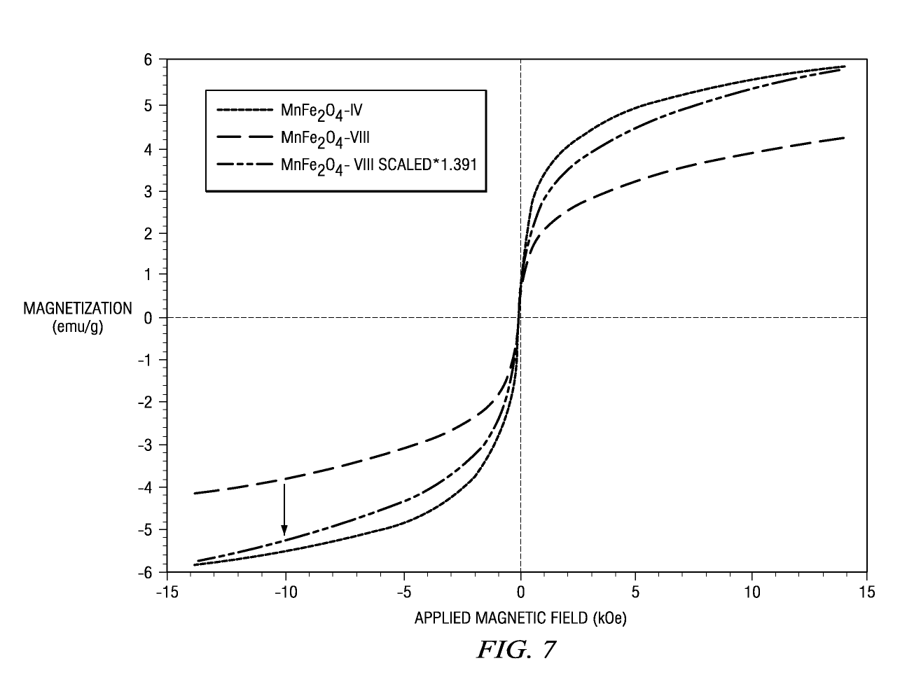

Turning now to FIG. 6, illustrated is a series of photographs showing a nanocomposite of MnFe₂O₄ formed within a polymer film according to the above described procedure, with the film containing 5%, 15% and 25% by volume of MnFe₂O₄ nanoparticles. The film was colorless prior to treatment. The nanoparticles range in size roughly from 5 to 10 nanometers (nm). The volume fraction of the nanoparticles was increased by repeating the ion exchange and precipitation procedures. The increase in nanoparticle concentration is readily apparent by the deepening of the red color of the polymer film with increased concentration as also illustrated with the deeper shading in FIG. 6. Regarding FIG. 7, illustrated is an enlarged electron micrographic view of nanoparticles of 5% MnFe₂O₄ by volume in a polymer film.

Cellulosic materials such as cotton, linen, rayon, and paper products may be used as starting materials. Because such materials do not have an ion exchange site, the process includes oxidation of the hydroxyl groups therein to carboxylate groups, followed by ion exchange and precipitation within a cellulosic structure. The structure could be in the form of pre-spun fibers, yarns, woven and non-woven textiles, wood, raw cotton, cotton bolls, paper, or cardboard. The nanomaterials can be magnetic metal oxides or magnetic metallic alloys, or a combination thereof, including nanomaterials with nonmagnetic properties. Magnetic functionality includes soft and hard magnets, magnetoresistive or magnetostrictive materials. Such nanoparticles are expected to provide improved materials for various additional applications such as functionally conformable materials, micromagnetics for power generators in cloth forms (clothing, canvas covers, etc.), actuators for valves, micropumps, electrical switches, and micro-mirrors, memory storage devices, bar-coding (potentially invisible), proximity or direction sensors, capillary peristaltic pumps, and controlled displacement or positioning devices including macro- and micro-devices.

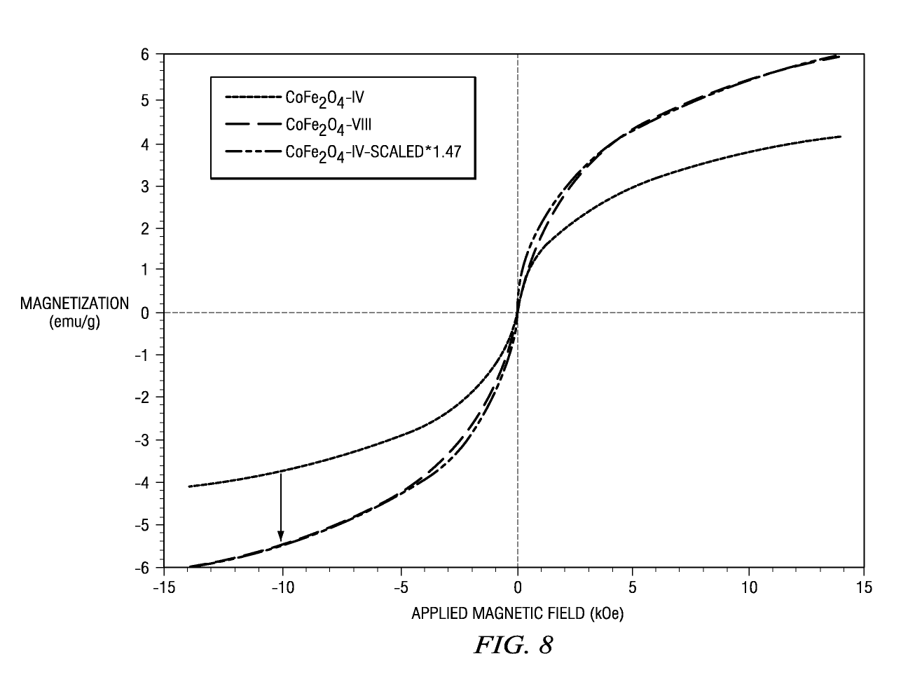

Turing now to FIG. 8, illustrated is a generalized chemical structure of cellulosic materials, which are polymeric hydrocarbon, non-aromatic, six-membered rings linked by oxygen atoms. Each ring contains a primary alcohol group (CH₂OH). These primary alcohols can be converted to potassium carboxylate groups by oxidation with oxidizing agents such as potassium permanganate:

R—CH₂OH+KMnO₄→R—CO₂⁻K⁺+H₂O+MnO₂,

wherein R—CH₂OH represents a repeating section of the cellulosic polymer.

The remainder of the process is similar to the procedure described above. The potassium ions are “ion exchanged” with other metal ions, followed by precipitation. A soluble metal salt is ion-exchanged with the potassium in the carboxylated cellulose as follows:

nR—CO₂⁻K⁺+M⁺→(R—CO₂⁻)ₙMⁿ⁺+nK⁺,

wherein M can be Fe²⁺, Fe³⁺, Co²⁺, Ni²⁺, Mn²⁺, Zn²⁺, or a variety of other metal ions, or a combination of such metal ions, where the metals form insoluble oxides. After ion exchange, the metal ion is reacted with an alkali metal base such as sodium hydroxide in air:

n(R—CO₂⁻)Mⁿ⁺+NaOH/O₂→n(R—CO₂Na⁺)+M₂Oₙ

to form the metallic oxide. A 60° C. processing temperature is a preferred temperature. However, different temperatures in the range of about 20° C. to about 100° C. may be more efficient due to the greater basicity of the carboxylate group compared to the sulfonate group described hereinabove. This process can be repeated indefinitely to increase the volume fraction of the nanoparticles within the cellulosic matrix. As with the process using the sulfonated polymer described hereinabove, reduction with sodium borohydrate could be done instead, resulting in precipitation of metallic alloys of nanoparticles.

Unlike the sulfonated Teflon polymer, there are no physical bounds to particle growth in the cellulosic substrate. The nanoparticles will grow within a fiber or yarn structure. Size and concentration are controlled by reaction conditions including reactant concentration, reaction time and temperature, and the number of repetitions. At 80° C. and 5 repetitions, each with reaction time of about 2 hours, iron oxide nanoparticles were obtained, evident by the color change and magnetic behavior.

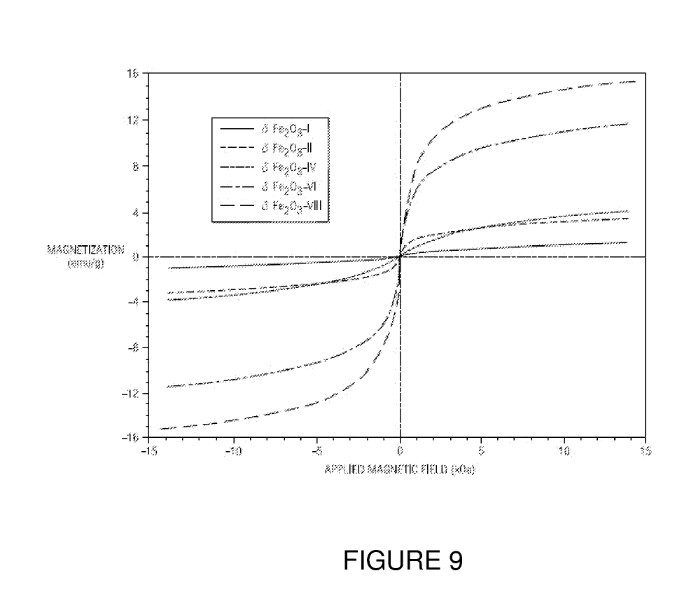

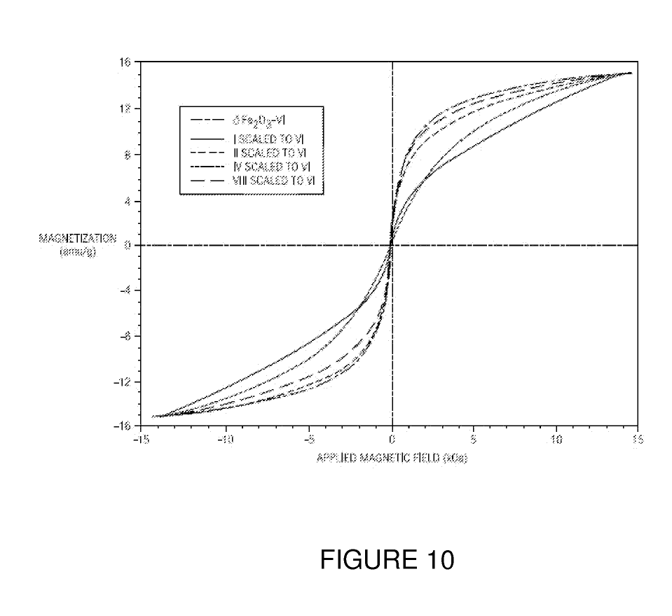

Turning now to FIGS. 9 and 10, illustrated is the change in magnetic properties for a series of nanocomposite films of Nafion containing an increasing volume fraction of iron oxide nanoparticles, from approximately 1% to 16% by weight, as a result of repeating the process described above multiple times, in this instance, 1, 2, 4, 6 and 8 repetitions. The increase in concentrate was initially estimated to be approximately 2% by weight per repetition. FIG. 10 shows the other curves normalized to the curve for 6 repetitions.

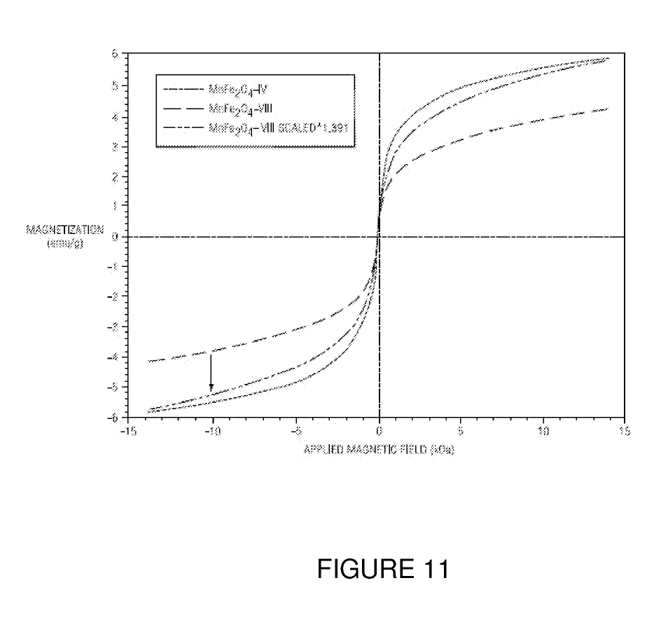

Turning now to FIG. 11, illustrated is a comparison of the magnetic properties for Nafion—MnFe₂O₄ nanocomposite films with MnFe₂O₄ (after 4 repetitions) and MnFe₂O₄ (after 8 repetitions, with the 8-repetition curve scaled 1.391 times). While the process was expected to produce a 2% increase in concentration for each repetition, in practice, it was found to produce a 1.39% increase per repetition.

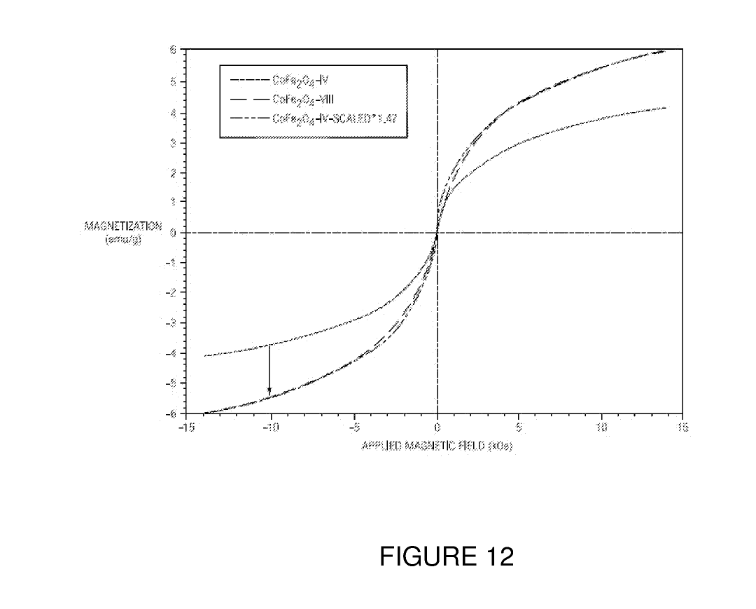

In a like manner, FIG. 12 compares the magnetic properties for Nafion—CoFe₂O₄ films with CoFe₂O₄ (after 4 repetitions) and CoFe₂O₄ (after 8 repetitions). When the curves are scaled 1.47 times, the curve is substantially the same for the 4- and 8-times repeated CoFe₂O₄ nanocomposite film, each repetition thus yielding about 1.47%, similar to the MnFe₂O₄ nanocomposite films. These graphs demonstrate that there is little effect of loading concentrations on magnetic properties after several repetitions. Although magnetic properties scale with loading concentration up to 8 repetitions, even more enhanced magnetic interaction may be expected at loadings exceeding 8 repetitions. Higher loadings would possibly lead to closer spacing between the nanoparticles within the ionic cluster regions of the polymer, and therefore enhanced interactions between the nanoparticles.

As indicated above, this procedure also provides a means for synthesizing different materials and combinations of materials within the same host matrix. Further, different metal oxides can be deposited in subsequent cycles of the process. For example, and solely for illustrative purposes, Fe₂O₃ can be deposited in early stages, followed by NiFe₂O₄, which may then be followed by CoFe₂O₄. In this manner, a flexible matrix with specifically designed magnetic or nonmagnetic properties or functions from different materials can be constructed.

Other magnetic metallic alloys as well as other unique compositions or alloys with nonmagnetic properties can also be produced by reduction of metallic ions. As an example, by reacting the ion-exchanged composite with sodium borohydride (NaBH₄), magnetic materials such as Permalloy (NiFe), samarium-cobalt, manganese-iron, cobalt-iron, or neodymium-boron can be formed. Sodium borohydride can also be used to reduce carboxylate and hydroxyl groups in a cellulosic structure, resulting in various different cellulosic reaction products, resulting from, but not limited to, cleavage of the carboxyl group, cross-linking of the polymer, or combinations thereof.

In a typical synthesis starting with a substrate of a Nafion proton exchange membrane 5 to 10 centimeters (cm) square, which is about 2″ to 4″ square, with a thickness of 50 micrometers (about 0.002″) or perfluorosulfonic acid polymer tubes or fibers (about 30-40 grams of substrate), the procedure can be used as set forth below.

First, the substrate material is ion exchanged at room temperature with stirring for 1 hour, typically in 400 milliliters (ml) of aqueous solution. Examples of the solutions that can be used for specific nanomaterials are set forth below.

| | METAL OXIDE OR |
|---|---|
| | METALLIC ALLOY |
| SOLUTION COMPOSITION | PRODUCED |
| 1:1 ratio of 0.05 M MnCl₂, and 0.1 M FeCl₂ | MnFe₂O₄ |
| 1:2 ratio of 0.05 M Co(NO₃)₂ and 0.1 M FeCl₂ | Fe₂O₃ |
| 0.0358 M FeCl₂ and 0.1368 M NiSO₄ | NiFe (80% Ni) alloy |
| 0.1 M Zn(NO₃)₂ | ZnO |
| ZnO is non-magnetic, however, it is | |
| phosphorescent | |

Second, after ion exchange, the substrate is washed thoroughly using deionized water. Third, to produce CoFe₂O₄, Fe₂O₃, or ZnO, 20 ml of 12 M NaOH with 2 ml 10% H₂O₂ is then added dropwise into the ion-exchange material at 80° C. The H₂O₂ ensures that the Fe (II) is oxidized to Fe (III). The substrate is then heated for about 30 minutes to complete the reaction. The substrate is then washed thoroughly using deionized water, preferably 7-10 times. The steps above are repeated to increase nanoparticle loading. For example, 20 repetitions result in 30% to 45% by volume loading of the nanomaterial. The percentage by weight is much higher since the density of the nanomaterials is greater than the polymer.

Fourth, for MnFe₂O₄, 12 M NaOH is used without hydrogen peroxide, since hydrogen peroxide was found to change the valence state of manganese. Fifth, for 80% Ni-20% Fe alloy, after reaching the desired composition upon ion exchange, the product is reduced using 30 ml of 2.5 M NaBH₄. Using a 2″-3″ square of a pre-washed textile composed of cellulosic fibers (e.g., a fine cotton weave, 90 picks/inch) as a substrate, the substrate material is prepared by oxidizing the hydroxyl groups (OH) in cellulose to carboxylic acid groups (COOH).

This is accomplished in two steps. First, the cellulose is oxidized with about 0.05 M aqueous potassium permanganate (KMnO₄). This yields the carboxylate salt RCOO⁻K⁺ wherein R is the cellulosic backbone:

RCH₂OH+KMNO₄→RCOO⁻K⁺+MnO₂+KOH.

The carboxylate is then converted to the acid form:

RCOO⁻K⁺+HCl(aq)→RCOOH+KCl(aq).

The procedure used for the Nafion or perfluorosulfonic acid polymer described above is then used to precipitate ion-oxide particles within the fibers of the fabric. The protons can be ion-exchanged with Fe₂⁺ or Fe₃⁺ ions, followed by precipitation of iron oxide, similar to the ionic polymer procedure described earlier. Ion exchange typically requires 12 hours for completion, rather than 1 hour as above. Two reasons for this difference are that the carboxylic acid proton is less mobile than the protons in highly cationic ion-exchange polymers, and the capacity for ion exchange in the cellulosic material is much lower.

While the process above is described for specific soluble metallic salts, one skilled in the art will recognize that the process may be used for a broad range of soluble metallic salts which may be converted to insoluble forms (i.e., insoluble oxides) by subsequent reactions. Also, one skilled in the art will recognize that the described process is not limited to the production of matrix materials with magnetic properties. A broad range of metals or metal-containing precipitates can be formed within the matrix for numerous other applications including, but not limited to, phosphorescent materials, energy absorbing materials (i.e., electromagnetic, nuclear radiation), semiconductors, or high strength composites, or precursors for these composites.

One skilled in the art will also recognize that the precursor materials are not limited to the ionomers or cellulosic materials described. Other polymeric materials with reactive pendant replaceable groups (i.e., H⁺ Na⁺, K⁺ etc.) —OH, COOH, or groups replaceable with other pendant groups that will react with or exchange with cations in the metal salt may be used. Examples of other useable polymer substrates/matrices include polyamides, epoxies, polyurethanes, vinyl, phenolics, and polyester resins.

The processes described above result in magnetic, magnetostrictive, magneto-optic, or phosphorescent nanocomposites processed directly into final shapes such as fibers, films, tubes and textile sheets. No machining, tape casting or other processes are required. This provides the ability to directly make a nanocomposite in a final desired shape in one processing step. While powders of nanocomposites made by ion exchange and precipitation are shown in the literature, they are not suitable for use in the formation of finished shapes since further processing to form these shapes requires mixing and dilution with a binder or other polymer and heating to make a solid body. This causes nanoparticles to grow, and the superior magnetic properties will cease to exist.

The shape, size, and volume fraction of the magnetic, magnetostrictive, magneto-optic, or phosphorescent nanoparticles embedded in the polymer matrix have a profound effect on its final properties. The process described herein allows for control of the nanoparticle shape, size, and volume fraction. The nanocomposite powders (or beads) made by prior art techniques only yield spherical particles because the shape of the ionic cluster is spherical. A spherical shape is not desirable for increasing the magnetic permeability or dielectric constant of nanocomposites. In fibers, films, and tubes, the ionic cluster is ellipsoidal due to stretching, and this yields ellipsoidal nanoparticles, with permeability higher in one direction. Interaction between nanoparticles is determined by their spacing and their volume fraction, both of which can be increased in the process described by repeating the ion exchange and precipitation procedures. This also has a profound effect on permeability, permittivity, saturation flux density, and loss. The process described provides the ability to synthesize magnetic nanoparticles in a magnetic field or ferroelectric nanoparticles in an electric field, thus imparting an anisotropy, which is desirable for certain applications.

Mixed compounds (such as MnFe₂O₄) and metallic alloys (such as Ni—Fe) can be made by this process due to the close proximity of ion-exchange sites in the polymer. As an example, the process can provide mixed compounds rather than separate MnO and Fe₂O₃ nanoparticles or separate Ni and Fe nanoparticles. Mixed compounds form spinels (metallic oxides, or ferrites) and therefore have much higher magnetization (or dielectric constant in the case of ferroelectric nanoparticles) than individual compounds. Unique metallic alloys, for example samarium-cobalt or neodymium-iron-boron, can be produced by using solutions of mixed soluble salts or sequentially applying different salt solutions. By utilizing excess borohydride, some boron may also be incorporated in the end product.

Also, mixtures of either mixed or simple compounds can be made. This is a unique feature of the process described herein that is not shown in the prior art. In other words, one can make compound A in a first step, and then make compound B adjacent to compound A in a second step. As an example, nanocomposite magnetodielectrics can be synthesized. The presence of an electric field in a ferroelectric nanoparticle adjacent to a ferromagnetic or ferrimagnetic nanoparticle can accentuate the permeability and permittivity in ways that the individual compounds do not exhibit. In a like manner, red, green, and blue nanophosphors can be synthesized in the same polymer film, rather than requiring three separate films to yield white light.

These nanocomposite films also have conformability and flexibility. No prior art process has been demonstrated that is capable of producing high performance magnetic, magnetostrictive, magneto-optic, or phosphorescent materials that are flexible. Prior available pure ceramics or metals and composites are either brittle or exhibit large losses at high frequency, and pure polymers do not exhibit large enough permittivity or permeability. Composites made by prior art techniques of mixing polymers with ceramic or metallic functional materials are restricted to low volume fractions (about 10-20%), which are not high enough to make high performance conformable materials. The processes described herein can produce conformable nanocomposites with suitable properties having 40-50% by volume metallic alloy or metal oxide functional nanomaterials. These nanocomposite films also preserve the mechanical strength and thermal stability of the matrix material because of the reinforcement provided by the nanocrystallites in the composite so formed.

It has been also found that the nanocomposite films produced by processes incorporating features of the invention swell or expand as nanoparticles are deposited therein. This allows for further loading of additional functional nanoparticles without agglomeration. This allows the synthesis of magnetic and ferroelectric nanoparticles in close proximity to each other, imparting certain properties not found in prior produced individual phases.

The nanoparticles made by the process set forth herein can be embedded into cotton textiles, or the cotton textile itself can be rendered magnetic or magnetodielectric. As a result, the process has the ability to form ferroelectric and ferromagnetic (or ferrimagnetic) nanoparticles in cotton to provide electronic textiles usable for antennas, power converters, electromagnetic interference (EMI) suppression, etc. Using Zn²⁺ salts (for example, nitrate or chloride salts) as starting materials, the procedures described herein also allow direct synthesis of monolithic films of Nafion or cellulosic material with concentrations of up to about 20% of phosphorescent nanoparticles. These films have been demonstrated to emit visible light when exposed to ultraviolet (UV) light. Phosphorescent nanoparticles deposited by the process described possess higher luminescent efficiency than the same materials in bulk. Further, high refractive index nanoparticles can be synthesized in the film along with the phosphor nanoparticles, providing higher efficiency of light coupling for display applications. Still further, multiple different colored phosphors, such as red, green and blue phosphors, can be synthesized within the same film, thus allowing white light emission from a monochromatic light source.

While the invention is primarily directed to the formation of magnetic materials, the teachings herein are applicable to a broad range of metals or combinations of metals that form soluble salts, for example, gallium (Ga), silver arsenic (AgAs), selenium (Se), indium antimony (InSb) and silicon (Si). These metals can be attached to the polymer in a like manner using a borohydride or more active reducing agents as a reducing agent. It is also not necessary to limit the process to aqueous solutions; other solvents can be used as long as they do not negatively affect the substrate material. Still further, using the described process, it is possible to produce elongated particles by subjecting the polymer substrate to tension, or drawing the polymer into elongated fibers during the formation process.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of forming a nanocomposite, comprising:
placing a polymer matrix having ion exchangeable groups pendant therefrom into a solution containing metal ions of a soluble salt dissolved therein, said metal ions replacing said ion exchangeable groups within said polymer matrix to form a treated polymer matrix with attached metal ions;
reacting said treated polymer matrix with an alkali base causing said attached metal ions to oxidize to form a metal oxide dispersed throughout said treated polymer matrix; and
reacting said treated polymer matrix with a reducing agent, causing said attached metal ions to form a metallic alloy dispersed throughout said treated polymer matrix.

2. The method as recited in claim 1 wherein said metal oxide is a magnetic oxide and said metallic alloy is a magnetic metallic alloy.

3. The method as recited in claim 1 wherein said metallic alloy is selected from the group consisting of Ni—Fe, Sm—Co, Mn—Co, Sm—Fe, Mn—Fe, Co—Fe, and combinations thereof.

4. The method as recited in claim 1 wherein said metal oxide is selected from the group consisting of MnFe₂O₄, CoFe₂O₄, NiFe₂O₄, Fe₂O₃, ZnO, and combinations thereof.

5. The method as recited in claim 1 wherein said metal oxide is a phosphorescent material.

6. The method as recited in claim 1 further comprising performing both steps of reacting to form a nanocomposite including a ferroelectric material adjacent to at least one of a ferromagnetic material and a ferrimagnetic material.

7. The method as recited in claim 1 wherein said treated polymer matrix is a flexible matrix.

8. The method as recited in claim 1 further comprising repeating the steps of said reacting said treated polymer matrix with an alkali base and reacting said treated polymer matrix with a reducing agent a plurality of times.

9. The method as recited in claim 1 wherein said reducing agent includes NaBH₄.

10. The method as recited in claim 1 wherein said ion exchangeable groups are H⁺ or a cation.

11. The method as recited in claim 1 wherein said polymer matrix is selected from the group consisting of a sulfonated polymer, cellulosic materials, polyamides, epoxies, polyurethanes, vinyls, phenolics and polyester resins.

12. The method as recited in claim 1 wherein said metal ions are selected from the group consisting of ions of Mn, Fe, Co, Ni, V, Cr, Zn, and Sm, and combinations thereof.

13. The method as recited in claim 1 wherein said metal oxide includes phosphorescent ZnO nanoparticles.

14. The method as recited in claim 1 further comprising heating said solution to an elevated temperature up to about 100° C.

15. The method as recited in claim 1 wherein said alkali base is selected from the group consisting of sodium hydroxide and potassium hydroxide, and combinations thereof.

16. A mixed compound comprising a metal oxide, a metallic alloy, and a polymer matrix, wherein said metal oxide and said metallic alloy are dispersed within said polymer matrix.

17. The mixed compound as recited in claim 16 wherein said metal oxide is a magnetic oxide and said metallic alloy is a magnetic metallic alloy.

18. The mixed compound as recited in claim 16 wherein said metallic alloy is selected from the group consisting of Ni—Fe, Sm—Co, Mn—Co, Sm—Fe, Mn—Fe, Co—Fe, and combinations thereof.

19. The mixed compound as recited in claim 16 wherein said metal oxide comprises a metal ferrite compound corresponding to a general formula MlFe₂O₄, wherein Ml comprises a metal selected from the group consisting of manganese, cobalt, samarium, nickel, and combinations thereof.

20. The mixed compound as recited in claim 16 wherein said polymer matrix is selected from the group consisting of a sulfonated polymer, cellulosic materials, polyamides, epoxies, polyurethanes, vinyls, phenolics and polyester resins.

21. A method of forming a nanocomposite, comprising:
contacting a polymer matrix having ion exchange groups with a solution of first metal ions, thereby attaching said first metal ions to said ion exchange groups;
oxidizing said first attached metal ions with an alkali base, thereby dispersing a metal oxide throughout said polymer matrix;
contacting said polymer matrix with a solution of second metal ions, thereby attaching said second metal ions to said ion exchange groups; and
reducing said second attached metal ions with a reducing agent, thereby dispersing a metallic alloy throughout said polymer matrix.

22. The method as recited in claim 21 wherein said first and second metal ions comprise an element selected from the group consisting of Mn, Fe, Co, Ni, V, Cr, Zn, and Sm, and combinations thereof.

23. The method as recited in claim 21 wherein said first and second metal ions comprise different elements.

24. The method as recited in claim 21 further comprising regenerating said ion exchange groups between said oxidizing and said reducing.

25. The method as recited in claim 21 wherein said metal oxide is a magnetic oxide.

26. The method as recited in claim 21 wherein said metal oxide is selected from the group consisting of MnFe₂O₄, CoFe₂O₄, NiFe₂O₄, Fe₂O₃, ZnO, and combinations thereof.

27. The method as recited in claim 21 wherein said metallic alloy is a magnetic metallic alloy.

28. The method as recited in claim 21 wherein said metallic alloy is selected from the group consisting of Ni—Fe, Sm—Co, Mn—Co, Sm—Fe, Mn—Fe, Co—Fe, and combinations thereof.

29. The method as recited in claim 21 wherein said metal oxide includes phosphorescent ZnO nanoparticles.

30. The method as recited in claim 21 wherein said metal oxide is a magnetic oxide and said metallic alloy is a magnetic metallic alloy, thereby forming a ferroelectric material adjacent at least one of a ferromagnetic material and a ferrimagnetic material.

31. The method as recited in claim 21 further comprising repeating said attaching said first and second metal ions to said ion exchange groups a plurality of times.

32. The method as recited in claim 21 further comprising repeating said reducing and said oxidizing a plurality of times.

33. The method as recited in claim 21 wherein one of said first and second metal ions comprises at least two elements selected from the group consisting of Mn, Fe, Co, Ni, V, Cr, Zn, and Sm, and combinations thereof.

34. The method as recited in claim 21 wherein said reducing agent includes NaBH₄.

35. The method as recited in claim 21 wherein said alkali base comprises sodium hydroxide or potassium hydroxide.

36. A nanocomposite comprising a metal oxide and an ionomeric or cellulosic polymer matrix, wherein said metal oxide is formed as nanoparticles including an ion exchange and precipitation procedure within said ionomeric or cellulosic polymer film.

37. The nanocomposite as recited in claim 36 wherein said metal oxide is a magnetic oxide.

38. The nanocomposite as recited in claim 36 wherein said metal oxide comprises a metal ferrite compound corresponding to a general formula MlFe₂O₄, wherein Ml comprises a metal selected from the group consisting of manganese, cobalt, nickel, and combinations thereof.

39. The nanocomposite as recited in claim 36 wherein said metal oxide comprises an element selected from the group consisting of Mn, Fe, Co, Ni, V, Cr, Zn, and Sm, and combinations thereof.

40. The nanocomposite as recited in claim 36 wherein said metal oxide comprises phosphorescent ZnO nanoparticles.

41. The nanocomposite as recited in claim 36 wherein said ionomeric or cellulosic polymer matrix comprises a polymer matrix having ion exchange groups.

42. The nanocomposite as recited in claim 41 wherein said polymer matrix of ion exchange groups comprises sulfonated polymer chains with hydrogen ions balancing a charge.

43. The nanocomposite as recited in claim 41 wherein a volume fraction of nanoparticles within said polymer matrix is controlled by repeating said ion exchange and precipitation procedure.

44. The nanocomposite as recited in claim 36 wherein said cellulosic polymer matrix comprises one of cotton, linen, rayon and paper products.

45. The nanocomposite as recited in claim 36 wherein said cellulosic polymer matrix is formed by oxidizing hydroxyl groups to carboxylate groups followed by an ion exchange and precipitation procedure within said cellulosic polymer matrix.

46. A method of forming a nanocomposite, comprising:
contacting an ionomeric or cellulosic polymer matrix with a solution of metal ions by an ion exchange and precipitation procedure, thereby attaching said metal ions to said ionomeric or cellulosic polymer matrix; and
oxidizing said metal ions with an alkali base, thereby dispersing a metal oxide as nanoparticles throughout said ionomeric or cellulosic polymer matrix.

47. The method as recited in claim 46 wherein said metal oxide is a magnetic oxide.

48. The method as recited in claim 46 wherein said metal oxide comprises a metal ferrite compound corresponding to a general formula MlFe₂O₄, wherein Ml comprises a metal selected from the group consisting of manganese, cobalt, nickel, and combinations thereof.

49. The method as recited in claim 46 wherein said metal ion comprises an element selected from the group consisting of Mn, Fe, Co, Ni, V, Cr, Zn, and Sm, and combinations thereof.

50. The method as recited in claim 46 wherein said metal oxide comprises phosphorescent ZnO nanoparticles.

51. The method as recited in claim 46 wherein said ionomeric or cellulosic polymer matrix comprises a polymer matrix having ion exchange groups.

52. The method as recited in claim 51 wherein said polymer matrix of ion exchange groups comprises sulfonated polymer chains with hydrogen ions balancing a charge.

53. The method as recited in claim 51 wherein a volume fraction of nanoparticles within said polymer matrix is controlled by repeating said ion exchange and precipitation procedure.

54. The method as recited in claim 46 wherein said cellulosic polymer matrix comprises one of cotton, linen, rayon and paper products.

55. The method as recited in claim 46 wherein said cellulosic polymer matrix is formed by oxidizing hydroxyl groups to carboxylate groups followed by an ion exchange and precipitation procedure within said cellulosic polymer matrix.

56. A nanocomposite comprising a metallic alloy and an ionomeric or cellulosic polymer matrix, wherein said metallic alloy is formed as nanoparticles including an ion exchange and precipitation procedure within said ionomeric or cellulosic polymer matrix.

57. The nanocomposite as recited in claim 56 wherein said metallic alloy is a magnetic metallic alloy.

58. The nanocomposite as recited in claim 56 wherein said metallic alloy is selected from the group consisting of Ni—Fe, Sm—Co, Mn—Co, Sm—Fe, Mn—Fe, Co—Fe, and combinations thereof.

59. The nanocomposite as recited in claim 56 wherein said metallic alloy comprises elements selected from the group consisting of Mn, Fe, Co, Ni, V, Cr, Zn, and Sm, and combinations thereof.

60. The nanocomposite as recited in claim 56 wherein said metallic alloy is formed by reducing metal ions with a reducing agent, thereby dispersing said metallic alloy as nanoparticles throughout said ionomeric or cellulosic polymer matrix.

61. The nanocomposite as recited in claim 56 wherein said ionomeric or cellulosic polymer matrix comprises a polymer matrix having ion exchange groups.

62. The nanocomposite as recited in claim 61 wherein said polymer matrix of ion exchange groups comprises sulfonated polymer chains with hydrogen ions balancing a charge.

63. The nanocomposite as recited in claim 61 wherein a volume fraction of nanoparticles within said polymer matrix is controlled by repeating said ion exchange and precipitation procedure.

64. The nanocomposite as recited in claim 56 wherein said cellulosic polymer matrix comprises one of cotton, linen, rayon and paper products.

65. The nanocomposite as recited in claim 56 wherein said cellulosic polymer matrix is formed by oxidizing hydroxyl groups to carboxylate groups followed by an ion exchange and precipitation procedure within said cellulosic polymer matrix.

66. A method of forming a nanocomposite, comprising:
contacting an ionomeric or cellulosic polymer matrix with a solution of first and second metal ions, thereby attaching said first and second metal ions to said ionomeric or cellulosic polymer matrix; and
reducing said first and second metal ions with a reducing agent, thereby dispersing a metallic alloy as nanoparticles throughout said ionomeric or cellulosic polymer matrix.

67. The method as recited in claim 66 wherein said metallic alloy is a magnetic metallic alloy.

68. The method as recited in claim 66 wherein said metallic alloy is selected from the group consisting of Ni—Fe, Sm—Co, Mn—Co, Sm—Fe, Mn—Fe, Co—Fe, and combinations thereof.

69. The method as recited in claim 66 wherein said first and second metal ions are selected from the group consisting of Mn, Fe, Co, Ni, V, Cr, Zn, and Sm, and combinations thereof.

70. The method as recited in claim 66 wherein said reducing agent comprises NaBH₄.

71. The method as recited in claim 66 wherein said ionomeric or cellulosic polymer matrix comprises a polymer matrix having ion exchange groups.

72. The method as recited in claim 71 wherein said polymer matrix of ion exchange groups comprises sulfonated polymer chains with hydrogen ions balancing a charge.

73. The method as recited in claim 71 wherein a volume fraction of nanoparticles within said polymer matrix is controlled by repeating said ion exchange and precipitation procedure.

74. The method as recited in claim 66 wherein said cellulosic polymer matrix comprises one of cotton, linen, rayon and paper products.

75. The method as recited in claim 66 wherein said cellulosic polymer matrix is formed by oxidizing hydroxyl groups to carboxylate groups followed by an ion exchange and precipitation procedure within said cellulosic polymer matrix.
